(19) United States
(12) Patent Application Publication
(10) Pub. No.: US 2004/0250261 A1
(43) Pub. Date: Dec. 9, 2004

(54) Method and system for displaying event information correlated with a performance parameter of a managed system

(76) Inventor: Thomas P. Huibregtse, Ft. Collins, CO (US)

Correspondence Address: HEWLETT-PACKARD COMPANY, Intellectual Property Administration, P.O. Box 272400, Fort Collins, CO, 80527-2400, US

(21) Appl. No.: 10/454,607

(22) Filed: Jun. 5, 2003

(51) Int. Cl. G06F 9/46

(52) U.S. Cl. 719/318

(57) ABSTRACT

A method and system are disclosed for displaying event information associated with an event in a managed system correlated with a performance parameter of the managed system. According to an exemplary embodiment a message is received including the event information, and the performance parameter of the managed system is monitored. The event information is correlated with the performance parameter using an attribute of the message. An image of the correlated event information and performance parameter is displayed to aid in determining a cause of the event.

### BACKGROUND

### Background Information

In many fields of process and performance management, operators face technical challenges as they work to identify the root cause of problems or events. The process of identifying the root cause of an event can involve numerous steps. For example, a computer network operator may receive a fault message on a management console, indicating that an event is occurring in a specific part of the managed system, e.g., that a particular service available in the system is no longer operating.

Event browsers are usually scrollable tables of information, allowing operators to view a list of event messages. Event browsers typically include information about the times at which events occurred, the entity within the managed system at which the event originated or was detected, and a text description of the event itself. Event browsers can also include mechanisms for sorting, filtering, counting, and grouping events. Exemplary components that can be used to create an event browser include the Java® JTable component, included in the Java development environment provided by Sun Microsystems, Inc., and the Spreadsheet ActiveX® object, available in Microsoft's MSDN technology. Functional event browsers are included in Hewlett Packard's (HP's) OpenView Network Node Manager (NNM) and SMARTS' InCharge™ products.

Upon receiving an event notification, the operator can reference a database of parametric data that includes managed system parameter measurements that characterize the operational state and performance of the system. This data can include measurements of the traffic load of a managed network, or perhaps information relating to specific user applications operating in the managed system. In browsing through the parametric data, the operator searches for trends in the data that can provide clues as to the root cause of the event. The operator can search the data measured around the time when the event notification is received to identify those performance parameters that can have a contributing or causal relationship to the event.

The complexity of today's managed systems, such as computer networks, make the task of identifying the causal relationships needed to determine the root causes of events a challenging one. System operators typically reference the separate parametric and message databases to identify the causal relationships. The process is inherently prone to human error, especially when an operator is attempting to correlate trends in several measured parameters with the information included in a number of separate, but related, event messages.

### SUMMARY

Accordingly, a method and system are disclosed for displaying event information associated with an event in a managed system correlated with a performance parameter of the managed system. According to exemplary embodiments, a message is received including the event information. In addition, a performance parameter of the managed system is monitored. The event information is correlated with the performance parameter using an attribute of the message. An image of the correlated event information and performance parameter is displayed.

### BRIEF DESCRIPTION OF THE DRAWINGS

The accompanying drawings provide visual representations which will be used to more fully describe the representative embodiments disclosed herein and can be used by those skilled in the art to better understand them and their inherent advantage. In these drawings, like reference numerals identify corresponding elements and:

FIG. 1 is a flowchart illustrating steps for displaying event information correlated with a performance parameter of the managed system;

FIG. 2 illustrates a system for displaying event information correlated with a performance parameter of the managed system according to a first embodiment; and

FIG. 3 illustrates a system for displaying event information correlated with a performance parameter of the managed system according to a second embodiment.

### DETAILED DESCRIPTION OF THE PREFERRED EMBODIMENTS

The techniques described herein can be applied in any managed environment. A managed environment (or system) is one in which the flow of information, products, services, and so forth, is monitored, and adjustments made to the system, to ensure a level of quality and performance in the delivery of the information, products, and services are achieved. The monitoring and management of these systems can be aided using management software. Exemplary managed systems can include the infrastructure that supports a manufacturing of products, and a communications infrastructure that supports the exchange of voice and data information. For illustration purposes, the techniques described herein are applied to a managed computer network, but the reader should not limit the application of the described concepts to this environment alone.

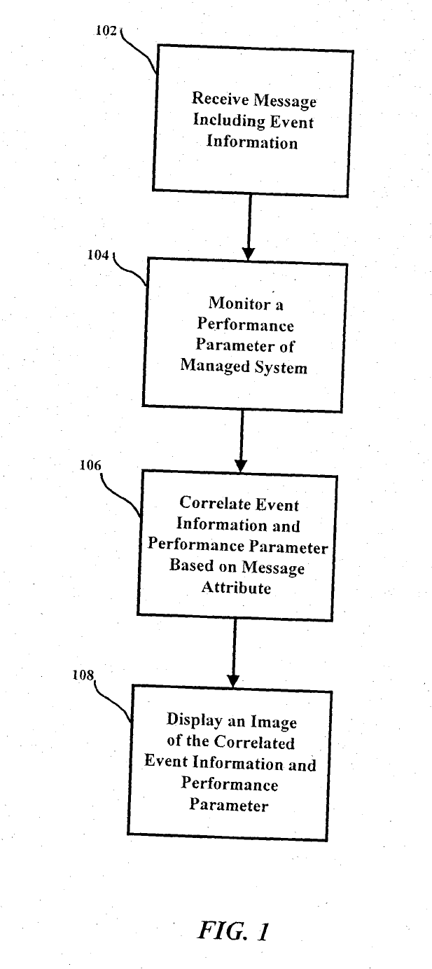

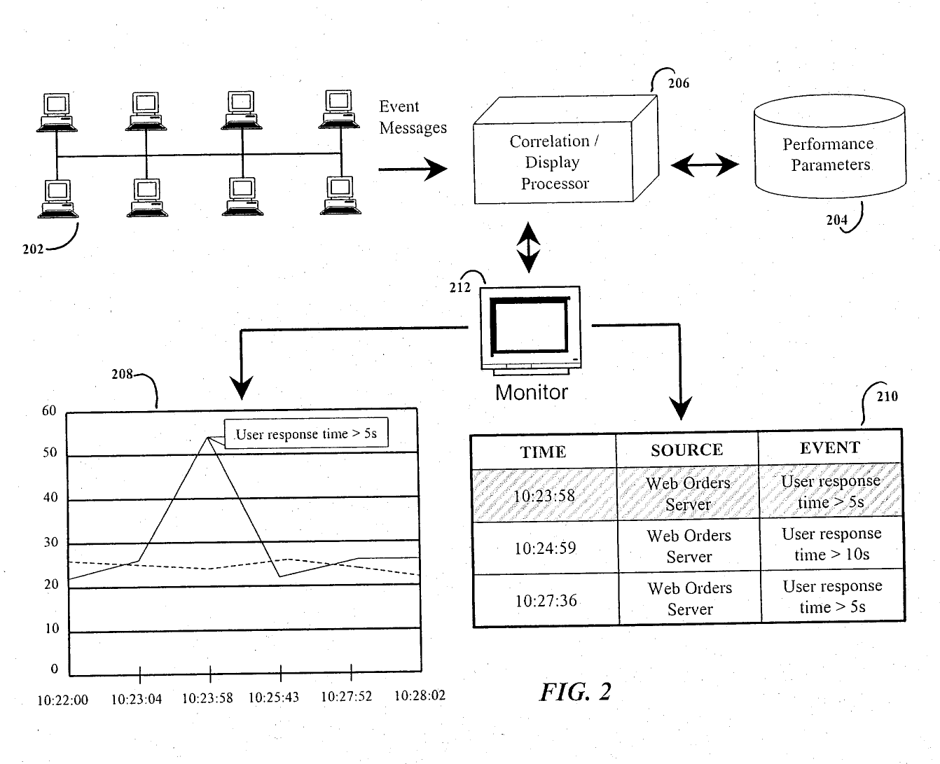

FIG. 1 is a flowchart illustrating steps for displaying event information correlated with a performance parameter of the managed system. In step 102, a message is received on a management station; for example, from software monitoring network performance in a managed network 202 as illustrated in FIG. 2. The message includes information associated with an event occurring in the exemplary network 202. As used herein, an “event” in a managed system can include any type of event or activity associated with the managed system. Event information can describe an irregularity in the performance or operability of the managed system related to the event.

According to exemplary embodiments, an event can include, but is not limited to, a computer (e.g., a computer server or any other type of computing system) or other computer network device (e.g., a switch, a router, etc.) in the computer network 202 going down or otherwise experiencing technical problems, a network connection going down or otherwise experiencing technical problems, a degradation in computer, computer network device or computer application performance, an attack on the computer network 202 (where an attack can include, for example, any unwanted intrusion or malicious activity into or on the computer network), or any other event or activity associated with the computer network 202. The computer network 202 can be a local area network (LAN), wide area network (WAN), any type of intranet or internet, an information technology (IT) management system, or any other type of computer network or computer system on which events can occur.

The event information included in the message received in step 102 can be captured using any type of computer software or computer/electronic system that is capable of capturing such event information in a computer system or computer network. HP's OpenView NNM product is an example of such a system. NNM is a network management solution designed to assist system administrators in the detection, solution, and prevention of problems occurring in computer networks, systems and applications in any enterprise. NNM receives event information from managed network elements and systems in Simple Network Management Protocol (SNMP) format, stores the event information in a management database, and makes the event information viewable and actionable in an event browser.

Although the foregoing example illustrates an exemplary embodiment for capturing the occurrence of an event (NNM) in the computer network, any monitoring computer system or software can be used to capture event messages and measurement information included in the message received in step 102 in accordance with exemplary embodiments of the present invention.

In step 104 of FIG. 1, a performance parameter of the managed system is monitored. The performance parameter can be, for example, a traffic load of the managed network 202, or perhaps information relating to specific user applications operating in the network 202. The performance parameter can also relate to a specific device or user terminal operating in the network 202, and can include a temperature, a response time, or a central processing unit (CPU) or memory utilization of the device.

The performance parameter can also include a measurement at a higher service level. For example, the performance parameter can describe the response time of a web page that is used for taking customer orders.

According to an exemplary embodiment, the performance parameter can be monitored over a period of time, and parametric data stored in a database accessible to devices operable within the managed system. The parametric data can be stored in the database together with a timestamp corresponding to each measured performance parameter data point.

The performance parameter can be monitored using any type of computer software or computer/electronic system that is capable of monitoring such parameters in a computer system or computer network. For example, HP's OpenView Performance Insight (PI) uses SNMP to gather information from monitored devices in a managed network. The measured information is stored in a database, and is then retrieved and formatted to make graphical chart-based reports.

In step 106, the event information included in the message received in step 102 and the performance parameter monitored in step 104 are correlated. As used herein, “correlating” refers to establishing a relationship between the event information and the monitored performance parameter. For example, the event information can be associated with the performance parameter, or vice versa, or the event information and the performance parameter can be combined to form a new, merged piece of information. However, any form of relationship can be established between the event information and the performance parameter when a correlation is performed.

The event information can be correlated with the performance parameter using an attribute of the message received in step 102. Thus, exemplary embodiments of the present invention use attributes of the received message to enrich or otherwise modify the performance parameter data with the event information included in the received message. The correlated performance parameter data can include, therefore, both the performance parameter data and the event information, the performance parameter data and a reference or other type of link to the event information, or any other form of relationship between the performance parameter data and the event information.

In step 108, an image of the correlated event information and the performance parameter are displayed. An operator can reference the displayed image to visually identify relationships that can exist between the correlated event information and the performance parameter. Displaying an image of the correlated event information and the performance parameter eliminates the need for the operator to separately reference the otherwise uncorrelated performance parameter and message databases to identify causal relationships. Any visually identified relationships can lead the operator to draw conclusions as to the root cause of the event occurring in the managed system.

According to an exemplary embodiment, the attribute of the message used to correlate the event information and the performance parameter in step 106 can be the time when the event occurred in the managed system. Recall that the performance parameter data can be stored in a database together with a timestamp corresponding to each measured performance parameter data point. Thus, according to exemplary embodiments, the correlating of the event information and the performance parameter using the time when the event occurred in the managed system forms a time-based relationship between the event information and the performance parameter. Displaying an image of the time-based relationship between the event and the performance parameter can aid the operator in determining the root cause of the event.

The event information can be correlated with a portion of the performance parameter monitored during at least one of a period before and a period after the time when the event occurred in the managed system. The duration of the period of the selected portion can be dependent upon many factors, including, but not limited to, the nature of the event, characteristics of the monitored performance parameter, or source of the message including the event information. Selecting the portion of the performance parameter monitored in a period before, after, or both before and after the time when the event occurred will aid the operator in identifying causal relationships between the monitored performance parameter and the event.

For example, the displayed image can show rapid fluctuations in a performance parameter (e.g., high network utilization) occurring at a time before an event is reported (e.g. a network failure), implying a contributing or causal relationship between the monitored performance parameter and the event reported in the received message. Similarly, the displayed image can show the operator that an event (e.g., a server failure), or a number of events, appear to lead to significant changes in a monitored performance parameter (e.g., an increased response time at a subscriber terminal) occurring in time after the event is reported in the message.

According to other exemplary embodiments, the monitored performance parameter can include data that crosses a predetermined threshold during at least one of a period before and a period after the time when the event occurred in the managed system. Thus, the monitored performance parameter correlated with event information can be automatically selected from a number of performance parameters when the monitored performance parameter includes data that crosses a predetermined threshold in a period before, after, or both before and after the time when the event occurred in the managed system. Again, the length of the period in which it is determined whether the performance parameter data crosses a predetermined threshold can depend on several factors, including, but not limited to, the nature of the information included in the event message, characteristics of the monitored performance parameter, or the managed system architecture.

The predetermined threshold can represent a change in the standard deviation of the monitored performance parameter. In computing the standard deviation of the monitored performance parameter, one can measure the standard deviation of the parameter in the period before, after, or before and after the event occurred in the managed system, and compare that “narrow” standard deviation with a “wider” standard deviation of the monitored performance parameter computed over a longer time frame. The predetermined threshold can also represent a change in the first, the second, or both the first and the second derivatives of the monitored performance parameter in the period before, after, or before and after the event occurred in the managed system. Choosing a predetermined threshold related to either a standard deviation change or to a derivative of the monitored performance parameter near the time when the event occurred helps in the selection of performance parameters that, when correlated with the event information, are likely to lead to the root cause of the event.

According to another exemplary embodiment, the monitored performance parameter can be associated with the event information. Thus, the monitored performance parameter can be automatically selected from a number of performance parameters when the monitored performance parameter is related, environmentally or otherwise, to the information included in the received event message. For example, assume a network event occurs, and an event message is received having information indicating that the network response time has fallen below a specified threshold value. A performance parameter related to the event information can be a parameter indicating the number of subscribers using the network at any given time.

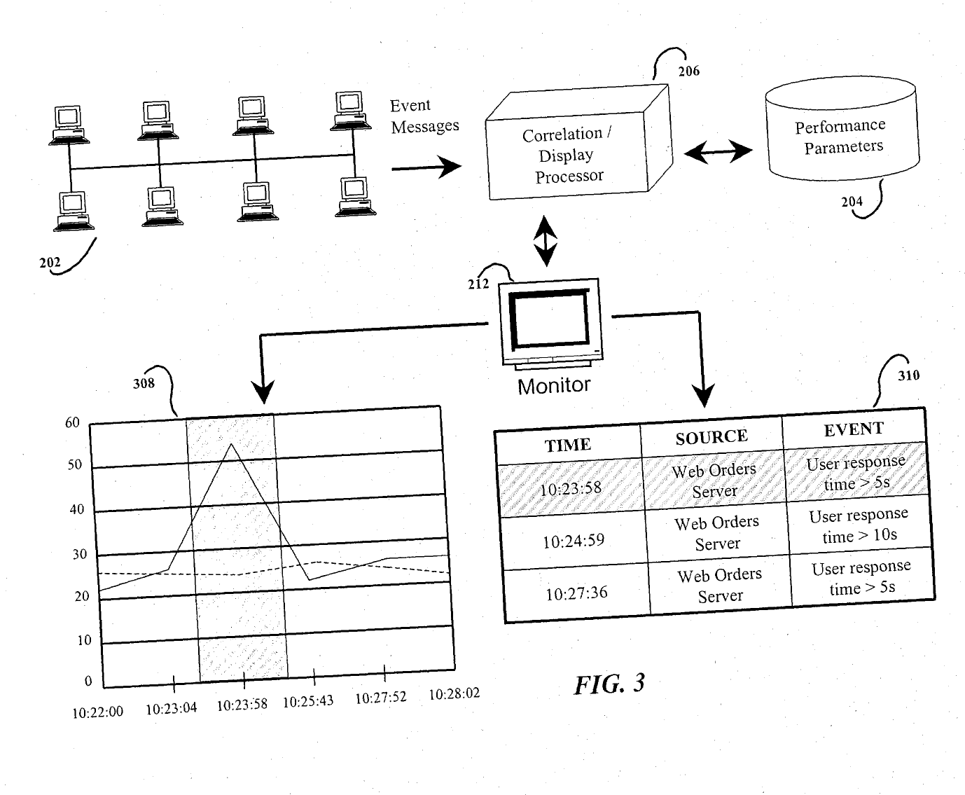

The message received at step 102 can be received into an event browser having a user interface for displaying and navigating among received event messages. An example of such an event browser is shown as elements 210 and 310 in FIGS. 2 and 3, respectively. According to exemplary embodiments, the correlating and displaying of the image can be activated through the event browser user interface. An event browser can be modified to add an action to each event displayed in the browser to invoke the correlating and displaying functionality. In the exemplary event browser 210 shown in FIG. 2, an action has been added to the events displayed in the event browser 210 to allow an operator to display a menu of selections. The menu shown in the example provides the operator with the option of displaying an image of the selected event (or events) correlated with one or more performance parameters (“Show with measures”).

As shown in FIG. 2, the action added to events can provide additional functionality to the event browser 210, for example allowing an operator to create a new “Trouble Ticket” (to enable problem resolution in an application such as the Remedy™ product by Peregrine Remedy, Inc.), to “Acknowledge” a particular event message, and to “Delete” a message displayed in the event browser. The “Trouble Ticket”, “Acknowledge”, and “Delete” actions have been implemented in commercial products, such as HP's OpenView NNM product. Several types of actions can be implemented, including pop-up menus as shown in FIG. 2, double-click selection, enabling options in a higher-level menu, and invoking the correlating and displaying functionality automatically when a new event is received.

According to exemplary embodiments, the image of the correlated event information and performance parameter can be displayed together with the event browser, and the displayed image linked to the displayed event browser using the message attribute. As referred to herein, the displayed image being “linked” to the displayed event browser refers to the establishing of a functional relationship between the displayed image of correlated information and the displayed event browser. Thus, the invoking of an action in the displayed event browser can cause the displayed image to automatically function in a particular manner, and vice versa. The functional relationship can be established using the same message attribute used to correlate the event and the performance parameter in step 106.

Recall that the attribute of the message used to correlate the event information and the performance parameter in step 106 can be the time when the event occurred in the managed system. Recall also that the correlating of the event information and the performance parameter can form a time-based relationship between the event information and the performance parameter using the timestamp corresponding to each measured performance parameter data point.

According to exemplary embodiments, event information associated with the received event message can be displayed in the image at a location corresponding to the message attribute of a message selected in the event browser. With the establishment of time-based relationships, event information associated with the received message can be displayed together with the performance parameter in the image on the same timescale. Thus, the event information can be displayed in the image at a location (or time) corresponding to the time when the event occurred in the managed system.

Such an exemplary arrangement is depicted in FIG. 2, which shows an image 208 of correlated performance parameters and event information being displayed together with the event browser 210. A time-based relationship between the performance parameters and event information can be established using the time(s) when the events occurred in the managed system. Also, the displayed image 208 and displayed event browser 210 are linked to one another using the same event time(s). FIG. 2 shows one of the displayed messages to be selected (indicated by the highlighting or shading) within the event browser 210. The selected message includes event information describing the selected event (“User response time >10 s”), the source of the selected event (“Web Orders Server”), and the time when the selected event occurred in the managed system (“10:24:59”). It will be understood that several messages can be selected in the event browser 210 at one time, for example, by positioning a cursor over the messages to be selected, holding down the “SHIFT” or “CTRL” keys on a computer keyboard, and “clicking” a mouse button.

The event browser 210 can be modified to add an action to the selected event to invoke the correlating and displaying functionality. Accordingly, the pop-up window action for the selected entry shown in FIG. 2 includes a menu function (“Show with measure”) that, when activated, can cause event information (“User response time >10 s”) for the selected message(s) to be automatically displayed in the image 208. The event information can be displayed in the image 208 at a time (“10:24:59) corresponding to the time when the event occurred in the managed system. In this example, web orders exceeded 50 (y-axis) at about 10:23:58 (x-axis), and led to an increased response time >5 s.

Relatively minor extensions can be added to graph components to display event information associated with the received event message in the image at a location corresponding to the message attribute of a message selected in the event browser. Such graph components are typically capable of displaying data values against time. Commercially available components include the Java component JChart™ from Sitraka, and the ActiveX™ ChartSpace object available from Microsoft.

The required extensions are to enable labels including event information to be displayed against time, together with the displayed data values if this capability does not already exist in the graph component. Although any type of label can be used to include the event information, an exemplary method includes the event information in so-called “balloons”, as depicted in the image 208 shown in FIG. 2. Balloon labels include a fine “tip” that allows the event information to be located on the graph at a precise point in time corresponding to the time when the event occurred in the managed system. Other types of labels that can be used include a “flag” having a extending down to the independent axis (e.g., indicating time), and a banner displaying the event information. Plain text labels could be added to the graph as well, but would be difficult to locate precisely at a point corresponding to the time when the event occurred in the managed system.

Additional extensions could be added such as an extension to automatically cause the graph to display the relevant timeframe of the selected event if not already being displayed. This would allow the operator to avoid having to scroll the display to view the correlated event. Each of these extensions can add annotations to the graph either by drawing in the graph component's “drawable” graphics, or by adding an “overlay” layer. An advantage to adding an overlay layer is that an operator can choose to display the annotations or not without having to redraw the entire graph.

According to exemplary embodiments, event information of a prior-selected message can be displayed for a predetermined time in the image after another message is selected in the event browser. This allows an operator to simultaneously view the correlation of several related events and performance parameters to visually identify causal relationships that can lead to a determination of the root cause of the related events.

Event information displayed in the event browser, and having a same message attribute as a selected portion of the image, can be highlighted in the event browser. Linking the display of the image to the event browser using the message attribute not only allows an action occurring in the displayed event browser to cause the displayed image to automatically function in a particular manner, but the reverse process as well.

For example, FIG. 3 shows a time-based correlation arrangement similar to the arrangement shown in FIG. 2, except that an action occurring in the image 308 causes the display browser to automatically function in a particular manner. In the exemplary arrangement, an operator selects a portion of the image 308 (indicated by the shaded region) corresponding to a timeframe of the monitored performance parameter. Typically, the operator will select the beginning of a timeframe with an input device, such as a mouse, and then “drag” the selection (holding the mouse button down) until the end of the timeframe is reached. Again, extensions can be added to the graph component used to display the image 308 if the graph component does not already support this capability.

Upon completion of the action of selecting a portion of the image 308, the display of the event browser 310 can be automatically modified to highlight messages having event information corresponding to events occurring in the selected timeframe. Thus, according to the exemplary arrangement, the first two messages displayed in the event browser are highlighted. The highlighted messages include information corresponding to events occurring during the selected timeframe. One of the highlighted event messages indicates that a response time for the Web Orders Server was >5 seconds at time 10:23:58, and the second event message indicates that the response time for the same server was >10 seconds at time 10:24:59.

The linking of the display of the image 208/308 and the event browser 210/310 enables operators to interactively identify potential causal relationships between the event information included in the received event messages and monitored performance parameters. Operators can select messages having related event information in the event browser 210, and then have the related event information, correlated with monitored performance parameters, automatically displayed in the image 208. Alternatively, operators can visually identify deviations in the displayed image 308 (e.g., peaks and valleys), select a portion of the image 308 that includes the deviations, and then have messages automatically highlighted in the event browser 310, to determine if the performance parameter deviations have caused (or were caused by) events that were reported in the event browser.

Various aspects of the invention will now be described in connection with exemplary embodiments. To facilitate an understanding of these embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both. Moreover, the exemplary embodiments can be considered part of any form of computer readable storage medium having stored therein an appropriate set of computer instructions that would cause a processor to carry out the techniques described herein.

Thus, the various aspects can be embodied in many different forms, and all such forms are contemplated to be within the scope of what is described. For each of the various aspects, any such form of embodiment can be referred to herein as “logic configured to” perform a described action, or alternatively as “logic that” performs a described action.

A system for displaying event information associated with an event in a managed system correlated with a performance parameter of the managed system according to a first embodiment is shown in FIG. 2. The system includes a processor 206 and a display 212. The processor 206 includes logic configured to receive a message including the event information, for example, in the computer network 202. The processor further includes logic configured to monitor the performance parameter of the managed system, and logic configured to correlate the event information and the performance parameter using an attribute of the message. An image 208 of the correlated event information and performance parameter is displayed on the display 212.

The processor 206 can be any computer program or software, electronic database, computer circuitry, computer firmware, computer hardware or any combination thereof that can be used for correlating the event information and the performance parameter using an attribute of the received message. For example, according to an exemplary embodiment, the processor 206 can be a computer program that can be used to manage or otherwise manipulate event information and monitored performance parameter data, organized and stored in any type of electronic storage medium, for correlating the event information with monitored performance parameter.

Exemplary pseudo-code for creating such a computer program will now be described. The pseudo-code is divided into two main sections—a correlation section and a display section. The correlation section includes functions to modify an existing event browser; auto-suggest parameters to correlation with a particular event, and perform the correlation of the event information and the monitored performance parameter. The display section includes functions to add extensions to an existing graph component to display an image of the correlated event information and monitored performance parameter, as well as link the display of the image with a message browser. It will be understood by one skilled in the art that the various functions needed to implement the computer program can be organized in other functional blocks, and thus the pseudo-code that follows is merely exemplary.

// Pseudo-Code to support correlating event information and
// a performance parameter using an attribute of a received
// event message
// Section 1: Correlation
// Section 1A: Modifications to Main Routine
/////////////////////////////////////////////////////////////////////
/////
// In a main routine, the event browser will already have been
// created, and is already receiving and displaying status and/or
// failure events.
//
// Functionality can be added to the event browser to add an action
// to each event displayed in the browser to invoke the correlating
// and displaying functionality.
/////////////////////////////////////////////////////////////////////
/////
// Format of callback:
// * specify the event browser (or individual events),
// * specify the name of the callback routine
// * specify the name of the callback routine
// * specify the name of the invocation conditions, e.g.,
// right-mouse click.
add_callback (eventbrowser, draw_eventgraph, ON_RIGHT_CLICK);
// End of Main Routine Modifications
// Section 1B: Time-based Extensions to Graph Component
/////////////////////////////////////////////////////////////////////
/////
// Callback routine invoked when user selects “Show measures” , e.g.,
// after selecting a message displayed in the event browser.
/////////////////////////////////////////////////////////////////////
/////
draw_eventgraph ( event_contents) {

| | |
|---|---|
| timestamp = get_timestamp (event_contents); | // Get time that |
| | // event occurred |
| flagtext = get_flagtext (event_contents); | // Event |
| | // information to |
| | // include in graph |
| GOOD_PARMS = auto_suggest_parms | // pass all |
| (ALL_PARMS); | |
| | // Monitored para- |
| | // meters; return |
| | // relevant/viable |
| | // parameters sources |
| draw_graph (timestamp, graph(GOOD_{—} | // Display the image |
| PARMS); | // including event |
| | // information |
| } | // end of callback |

// Section 1C: Auto-Suggest Parameters
auto_suggest_parms (ALL_PARMS) {
// Several methods are possible. Two methods will be discussed
// focusing on analyzing deviations in the monitored parameters
// around the time the event occurred.
// Option 1: Change in standard deviation
// For each monitored parameter, look at values in a narrow time
// window (before & after the event) and compare against a wider,
// timeframe.
std_deviation_test ( name_of_a_monitored_parameter,
event_timestamp, narrow_window_width, normal_window_width);
// Routine can return a Boolean (True/False), or a “goodness”
// rating, e.g., 0 to 10)
// Option 2: First and Second Derivatives
// Detect sharp changes in the parameter (first derivative) or sharp
// rate of changes (second derivative) among parameter data in a
// relatively narrow event window.
derivative_test ( name_of_a_monitored_parameter, event_timestamp,
narrow_window_width);
// Again, the return value of the function could be Boolean or a
// measure of “goodness”.

| | |
|---|---|
| return (LIST_OF_GOOD_PARAMETERS); | // Can be a list, or a |
| | goodness |
| | // ranking of different |
| | sources |

}
// Section 2: Extensions to existing Graph Component
// Section 2A: Extensions for Drawing Text Annotations
// Add extensions add text annotations, e.g., a “balloon” or “flag”
// to image at the times at which selected events occurred.
graph_component.add_annotation_layer;
// Add callback routine to asynchronously add new text annotations.
graph_component.add_callback (name_of_callback_routine);
// Section 2B: Extensions to highlight events based on a chosen
// time period in graph
graph_component.add_select_timeframe;
// Add callback routine to instruct the event browser to highlight
// the events that occurred in the selected time_frame.
// graph_component.add_callback (name_of_callback_routine);

The performance parameter can be monitored over a period of time, and parametric data stored in a database 204 accessible to devices operable within the computer network 202. The performance parameter data can be stored in the database 204 together with a timestamp corresponding to the time at which the data was monitored.

According to an exemplary embodiment, the logic configured to correlate can include logic configured to select a portion of the performance parameter monitored during at least one of a period before and a period after the time when the event occurred in the managed system to correlate with the event information. The logic configured to select a portion of the performance parameter can retrieve the portion from the database 204 coupled to the processor 206.

The logic configured to receive a message can include an event browser 210 having a user interface for displaying and navigating among received messages. Various event browsers and their functionality have been described in detail in conjunction with the exemplary method for displaying event information correlated with a performance parameter shown in FIG. 1. The correlating and displaying of the image 208 of the correlated information can be activated through the event browser 210 user interface.

According to other exemplary embodiments, the processor 206 can include a graph component configured to form the image 208 of the correlated event information and performance parameter. The processor 206 can also include logic configured to display the image 208 of the correlated event information and performance parameter together with the event browser 210 on the display 212, and logic configured to link the display of the image 208 to the event browser 210 using the message attribute.

The processor 206 can also include logic configured to display event information in the image on the display at a location corresponding to the message attribute of a message selected in the event browser, and logic configured to continue to display event information of a prior-selected message in the image on the display for a predetermined time after another message is selected in the event browser. One skilled in the art will understand that at least a portion of these logic blocks to display the image 208 can be included in the graph component of the processor 206.

A system for displaying event information associated with an event in a managed system correlated with a performance parameter of the managed system according to a second embodiment is shown in FIG. 3. Similar to the arrangement shown in FIG. 2, the system of FIG. 3 includes the processor 206 includes logic configured to receive a message including the event information, for example, in the computer network 202. The processor further includes logic configured to monitor the performance parameter of the managed system, and logic configured to correlate the event information and the performance parameter using an attribute of the message.

Similar to the image 208 shown in FIG. 2, an image 308 of the correlated event information and performance parameter are displayed on the display 212. According to an exemplary embodiment, the processor 206 includes logic configured to highlight event information displayed in the event browser 310 on the display 212 having a same message attribute as a selected portion of the image 308. The logic allows operators to visually identify deviations in the displayed image 308 (e.g., peaks and valleys), select a portion of the image 308 that includes the deviations, and then have messages including event information associated with the selection portion automatically highlighted in the event browser 310. This can enable the operator to determine if the selected performance parameter deviations have caused (or were caused by) events that were reported in the event browser 310. It will be understood by those skilled in the art that at least a portion of the logic configured to highlight event information can be incorporated into the event browser 310.

The steps of a computer program as illustrated in FIG. 1 for displaying event information associated with an event in a managed system correlated with a performance parameter of the managed system can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

As used herein, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A method for displaying event information associated with an event in a managed system correlated with a performance parameter of the managed system, the method comprising:
receiving a message including the event information;
monitoring the performance parameter of the managed system;
correlating the event information and the performance parameter using an attribute of the message; and
displaying an image of the correlated event information and performance parameter.

2. The method of claim 1, wherein the message attribute is a time when the event occurred in the managed system.

3. The method of claim 2, wherein the correlating comprises:
selecting a portion of the performance parameter monitored during at least one of a period before and a period after the time when the event occurred in the managed system to correlate with the event information.

4. The method of claim 2, wherein the monitored performance parameter includes data that crosses a predetermined threshold during at least one of a period before and a period after the time when the event occurred in the managed system.

5. The method of claim 1, wherein the monitored performance parameter is associated with the event information.

6. The method of claim 1, wherein the message is received into an event browser having a user interface for displaying and navigating among received messages.

7. The method of claim 6, wherein the correlating and displaying are activated through the event browser user interface.

8. The method of claim 6, comprising:
displaying the image of the correlated event information and performance parameter together with the event browser; and
linking the display of the image to the event browser using the message attribute.

9. The method of claim 8, comprising:
displaying event information in the image at a location corresponding to the message attribute of a message selected in the event browser.

10. The method of claim 9, comprising:
continuing to display event information of a prior-selected message in the image for a predetermined time after another message is selected in the event browser.

11. The method of claim 8, comprising:
highlighting event information displayed in the event browser having a same message attribute as a selected portion of the image.

12. The method of claim 1, wherein the event information displayed in the image includes text describing the event positioned at a location corresponding to the message attribute.

13. A system for displaying event information associated with an event in a managed system correlated with a performance parameter of the managed system, the system comprising:
a processor including:
logic configured to receive a message including the event information;
logic configured to monitor the performance parameter of the managed system; and
logic configured to correlate the event information and the performance parameter using an attribute of the message; and
a display for displaying an image of the correlated event information and performance parameter.

14. The system of claim 13, wherein the message attribute is a time when the event occurred in the managed system.

15. The system of claim 14, wherein the logic configured to correlate comprises:
logic configured to select a portion of the performance parameter monitored during at least one of a period before and a period after the time when the event occurred in the managed system to correlate with the event information.

16. The system of claim 14, wherein the monitored performance parameter includes data that crosses a predetermined threshold during at least one of a period before and a period after the time when the event occurred in the managed system.

17. The system of claim 13, wherein the monitored performance parameter is associated with the event information.

18. The system of claim 13, wherein the logic configured to receive a message comprises an event browser having a user interface for displaying and navigating among received messages.

19. The system of claim 18, wherein the logic configured to correlate and the displaying of the image of the correlated event information and performance parameter are activated through the event browser user interface.

20. The system of claim 18, wherein the processor comprises:
a graph component configured to form the image of the correlated event information and performance parameter;
logic configured to display the image of the correlated event information and performance parameter together with the event browser on the display; and
logic configured to link the display of the image to the event browser using the message attribute.

21. The system of claim 20, wherein the processor comprises:
logic configured to display event information in the image on the display at a location corresponding to the message attribute of a message selected in the event browser.

22. The system of claim 21, wherein the processor comprises:
logic configured to continue to display event information of a prior-selected message in the image on the display for a predetermined time after another message is selected in the event browser.

23. The system of claim 20, wherein the processor comprises:
logic configured to highlight event information displayed in the event browser on the display having a same message attribute as a selected portion of the image.

24. The system of claim 13, wherein the event information displayed in the image includes text describing the event positioned at a location corresponding to the message attribute.

25. A computer-readable medium containing a computer program for displaying event information associated with an event in a managed system correlated with a performance parameter of the managed system, wherein the computer program performs:
receiving a message including the event information;
monitoring the performance parameter of the managed system;
correlating the event information and the performance parameter using an attribute of the message; and
displaying an image of the correlated event information and performance parameter.

26. The medium of claim 25, wherein the message attribute is a time when the event occurred in the managed system.

27. The medium of claim 26, wherein the correlating comprises:
selecting a portion of the performance parameter monitored during at least one of a period before and a period after the time when the event occurred in the managed system to correlate with the event information.

28. The medium of claim 26, wherein the monitored performance parameter includes data that crosses a predetermined threshold during at least one of a period before and a period after the time when the event occurred in the managed system.

29. The medium of claim 25, wherein the monitored performance parameter is associated with the event information.

30. The medium of claim 25, wherein the message is received into an event browser having a user interface for displaying and navigating among received messages.

31. The medium of claim 30, wherein the correlating and displaying are activated through the event browser user interface.

32. The medium of claim 30, comprising:
displaying the image of the correlated event information and performance parameter together with the event browser; and
linking the display of the image to the event browser using the message attribute.

33. The medium of claim 32, comprising:
displaying event information in the image at a location corresponding to the message attribute of a message selected in the event browser.

34. The medium of claim 33, comprising:
continuing to display event information of a prior-selected message in the image for a predetermined time after another message is selected in the event browser.

35. The medium of claim 32, comprising:
highlighting event information displayed in the event browser having a same message attribute as a selected portion of the image.

36. The medium of claim 25, wherein the event information displayed in the image includes text describing the event positioned at a location corresponding to the message attribute.
